(19) United States
(12) Patent Application Publication
(10) Pub. No.: US 2026/0161508 A1
(43) Pub. Date: Jun. 11, 2026

(54) MANAGING PARITY DATA IN A MEMORY SYSTEM

(71) Applicant: Yangtze Memory Technologies Co., Ltd., Wuhan (CN)

(72) Inventors: Ruiyang ZHANG, Wuhan (CN); Xianwu LUO, Wuhan (CN)

(21) Appl. No.: 19/024,070

(22) Filed: Jan. 16, 2025

(30) Foreign Application Priority Data
Dec. 9, 2024 (CN) 202411808212.2

(51) Int. Cl. G06F 11/10

(52) U.S. Cl. CPC G06F 11/108; G06F 11/1016; G06F 11/1096

(57) ABSTRACT

Methods, apparatus, and systems for managing parity data generation are provided. In one aspect, a memory system includes a memory device and a memory controller. The memory device includes N dies each including M planes. Each of the M planes includes a first memory block that includes memory pages each associated with one of a set of word lines that are numbered in sequence. The memory controller is configured to generate first parity data for first data to be written to memory pages associated with a k^{th} word line of the first memory block of each of the M planes of each of the N dies, and generate second parity data for second data to be written to memory pages associated with at least a (k−1)^{th} word line and a (k+1)^{th} word line of the first memory block of each of the M planes of each of the N dies.

### CROSS-REFERENCE TO RELATED APPLICATIONS

This application claims priority to Chinese Patent Application No. 202411808212.2, filed on Dec. 9, 2024, which is hereby incorporated by reference in its entirety.

### TECHNICAL FIELD

The present disclosure generally relates to memory devices and memory systems, and in particular, to managing parity data in memory systems.

### BACKGROUND

Flash memory is a low-cost, high-density, nonvolatile solid-state storage medium that can be electrically erased and reprogrammed. Flash memory includes NOR flash memory and NAND flash memory. Various operations can be performed by flash memory, for example, program (write) and erase operations, to change the threshold voltage of each memory cell to a respective level. For NAND flash memory, an erase operation can be performed at the memory block level, a program operation can be performed at the page level, and a read operation can be performed at the page level.

### SUMMARY

The present disclosure involves methods, apparatuses, and systems for managing parity data in memory systems. One aspect of the present disclosure features a memory system including a memory device and a memory controller coupled to the memory device. The memory device includes N dies, each of the N dies including M planes, each of the M planes including a first memory block, where N, M are positive integers. The first memory block includes memory pages each associated with one of a set of word lines that are numbered in sequence. The memory controller is configured to perform operations comprising generating first parity data by performing a first encoding operation on first data to be written to memory pages associated with a k^{th} word line of the first memory block of each of the M planes of each of the N dies, where k is an integer greater than 1; generating second parity data by performing a second encoding operation on second data to be written to memory pages associated with at least a (k−1)^{th} word line and a (k+1)^{th} word line of the first memory block of each of the M planes of each of the N dies; and writing the first data, the first parity data, the second data and the second parity data to the memory device.

The present disclosure involves methods, apparatuses, and systems for managing parity data in memory systems. One aspect of the present disclosure features a memory system including a memory device and a memory controller coupled to the memory device. The memory device includes N dies, each of the N dies including M planes, each of the M planes including a first memory block, where N, M are positive integers. The first memory block includes memory pages each associated with one of a set of word lines that are numbered in sequence. The memory controller is configured to perform operations including generating first parity data by performing a first encoding operation on first data to be written to memory pages associated with a k^{th} word line of the first memory block of each of the M planes of each of the N dies, where k is an integer greater than 1; generating second parity data by performing a second encoding operation on second data to be written to memory pages associated with at least a (k−1)^{th} word line and a (k+1)^{th} word line of the first memory block of each of the M planes of each of the N dies; and writing the first data, the first parity data, the second data and the second parity data to the memory device.

In some implementations, the first parity data and the second parity data include redundant array of independent disks (RAID) parity data.

In some implementations, the second parity data is generated by performing the second encoding operation on the second data to be written to memory pages that are associated with a group of odd-numbered word lines of the first memory block of each of the M planes of each of the N dies.

In some implementations, the second parity data is generated by performing the second encoding operation on the second data to be written to memory pages that are associated with a group of even-numbered word lines of the first memory block of each of the M planes of each of the N dies.

In some implementations, a first ratio of a volume of the first parity data to a volume of the first data is greater than a second ratio of a volume of the second parity data to a volume of the second data.

In some implementations, the first parity data is written to a memory page associated with the k^{th} word line of the first memory block of the M^{th} plane of the N^{th} die. The second parity data is written to a memory page associated with the (k+1)^{th} word line of the first memory block of the M^{th} plane of the N^{th} die.

In some implementations, the memory controller is configured to perform the operations in response to receiving, from a host, one or more write commands to write the first data and the second data.

In some implementations, the first encoding operation and the second encoding operation each include a plurality of exclusive OR (XOR) operations. Results of the plurality of XOR operations are stored in a buffer of the memory controller.

In some implementations, the operations include in response to detecting a read failure when reading the first data, recovering the first data using the first parity data; or in response to detecting a read failure when reading the second data, recovering the first data using the first parity data.

Another aspect of the present disclosure features a memory controller. The memory controller includes one or more processors and an interface. The one or more processors are configured to perform operations including sending, through the interface, one or more first write commands to write first data and first parity data to a memory device; and sending, through the interface, one or more second write commands to write second data and second parity data to the memory device. The memory device includes N dies, each of the N dies including M planes, each of the M planes including a first memory block, where N, M are positive integers. The first memory block includes memory pages each associated with one of a set of word lines that are numbered in sequence. The first parity data is generated by performing a first encoding operation on the first data to be written to memory pages associated with a k^{th} word line of the first memory block of each of the M planes of each of the N dies, where k is a positive integer. The second parity data is generated by performing a second encoding operation on second data to be written to memory pages associated with at least a (k−1)^{th} word line and a (k+1)^{th} word line of the first memory block of each of the M planes of each of the N dies.

In some implementations, the first parity data and the second parity data include redundant array of independent disks (RAID) parity data.

In some implementations, the second parity data is generated by performing the second encoding operation on the second data to be written to memory pages that are associated with a group of odd-numbered word lines of the first memory block of each of the M planes of each of the N dies.

In some implementations, the second parity data is generated by performing the second encoding operation on the second data to be written to memory pages that are associated with a group of even-numbered word lines of the first memory block of each of the M planes of each of the N dies.

In some implementations, a first ratio of a volume of the first parity data to a volume of the first data is greater than a second ratio of a volume of the second parity data to a volume of the second data.

In some implementations, the first parity data is written to a memory page associated with the k^{th} word line of the first memory block of the M^{th} plane of the N^{th} die. The second parity data is written to a memory page associated with the (k+1)^{th} word line of the first memory block of the M^{th} plane of the N^{th} die.

In some implementations, the memory controller is configured to perform the operations in response to receiving, from a host, one or more write commands to write the first data and the second data.

In some implementations, the first encoding operation and the second encoding operation each include a plurality of exclusive OR (XOR) operations. Results of the plurality of XOR operations are stored in a buffer of the memory controller.

In some implementations, the operations include in response to detecting a read failure when reading the first data, recovering the first data using the first parity data; or in response to detecting a read failure when reading the second data, recovering the first data using the first parity data.

Another aspect of the present disclosure features a method of operating a memory system. The method includes generating first parity data by performing a first encoding operation on first data to be written to first memory pages of a memory device, generating second parity data by performing a second encoding operation on second data to be written to second memory pages associated with at least a (k−1)^{th} word line and a (k+1)^{th} word line of the first memory block of each of the M planes of each of the N dies; and writing the first data, the first parity data, the second data and the second parity data to the memory device. The memory device includes N dies, each of the N dies including M planes, each of the M planes including a first memory block, where N, M are positive integers. The first memory block includes memory pages each associated with one of a set of word lines that are numbered in sequence. The first memory pages are associated with a k^{th} word line of the first memory block of each of the M planes of each of the N dies, where k is a positive integer.

In some implementations, a first ratio of a volume of the first parity data to a volume of the first data is greater than a second ratio of a volume of the second parity data to a volume of the second data.

Another aspect of the present disclosure features a non-transitory, computer-readable medium. The non-transitory, computer-readable medium stores one or more instructions executable by a memory system to perform operations including generating first parity data by performing a first encoding operation on first data to be written to first memory pages of a memory device, generating second parity data by performing a second encoding operation on second data to be written to second memory pages associated with at least a (k−1)^{th} word line and a (k+1)^{th} word line of the first memory block of each of the M planes of each of the N dies; and writing the first data, the first parity data, the second data and the second parity data to the memory device. The memory device includes N dies, each of the N dies including M planes, each of the M planes including a first memory block, where N, M are positive integers. The first memory block includes memory pages each associated with one of a set of word lines that are numbered in sequence. The first memory pages are associated with a k^{th} word line of the first memory block of each of the M planes of each of the N dies, where k is a positive integer.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system having a memory device.

FIGS. 2A-2B illustrate example storage products.

FIG. 3A illustrates an example of a schematic diagram of a memory device including peripheral circuits.

FIG. 3B illustrates an example of a schematic diagram of a memory block including strings.

FIG. 4 illustrates some example peripheral circuits.

FIG. 5 illustrates a block diagram of an example memory controller interacting with a host and a memory device.

FIG. 6 illustrates an example data structure of a memory device under a Plane RAID scheme.

FIG. 7 illustrates an example data structure of a memory device under a 2WL RAID scheme.

FIG. 8 illustrates an example data structure of a memory device under a RAID scheme that combines Plane RAID and 2WL RAID.

FIG. 9 illustrates another example data structure of a memory device under a RAID scheme that combines Plane RAID and 2WL RAID.

FIG. 10 illustrates a flowchart of an example process of operating a memory system.

Like reference numbers and designations in the various drawings indicate like elements.

### DETAILED DESCRIPTION

This specification relates to memory controllers, memory systems, and methods for managing parity data in memory systems. Redundant-array-of-independent-disks (RAID) parity data can be used to recover data in case a read failure occurs (e.g., the read failure occurs because one word line fails). For example, a memory system can generate RAID parity data by performing exclusive OR (XOR) operations among data portions across one or more word lines.

In some cases, the memory system generates RAID parity data under a Plane RAID scheme or a 2WL RAID scheme, so that compromised data can be recovered in case two adjacent word lines fail at the same time (for example, due to current leakage). Under the Plane RAID scheme, the memory system generates RAID parity data by performing XOR operations among data portions that include user data in one page line. The Plane RAID scheme may result in a large ratio of the volume of RAID parity data to the volume of user data, which may limit the storage capacity of the memory device. Under the 2WL RAID scheme, the memory system generates RAID parity data by performing XOR operations among data portions in multiple page lines associated with word lines that are separated from one another by one word line. The 2WL RAID scheme may result in a large volume of intermediate results of XOR operations. In case the volume of the intermediate results exceeds the memory space of the random-access memory (RAM) of the memory controller, the memory controller may need to perform swap operations by sending the intermediate results to the memory device for temporary storage, and retrieving the intermediate results from the memory device when needed. The swap operations may affect the efficiency of write operations.

The present disclosure provides techniques to generate parity data under a RAID scheme that combines Plane RAID and 2WL RAID. In some implementations, the memory system can generate RAID parity data corresponding to page lines associated with a first group of word lines using the Plane RAID scheme, and generate RAID parity data corresponding to page lines associated with a second group of word lines using the 2WL RAID scheme. For example, the first group of word lines include even-numbered word lines, and the second group of word lines include odd-numbered word lines. For another example, the first group of word lines include odd-numbered word lines, and the second group of word lines include even-numbered word lines.

The described techniques can achieve one or more technical effects. For example, compared to the Plane RAID scheme, the described techniques can lower the ratio of the volume of RAID parity data to the volume of user data in the memory device. For another example, compared to the 2WL RAID scheme, the described techniques can reduce the volume of intermediate results of XOR operations for generating the RAID parity data. As such, the memory controller can store the intermediate results in the RAM, without needing to perform swap operations. Further, RAID parity data generated using the described techniques can be used to recover compromised data in case two adjacent word lines fail at the same time. In some implementations, additional or different technical effects can be achieved.

The techniques can be applied to various types of semiconductor devices, e.g., non-volatile memory (NVM) devices (such as NAND flash memory or NOR flash memory), volatile memory devices (such as DRAM memory devices), resistive random-access memory (RRAM), phase-change memory (PCM) such as phase-change random-access memory (PCRAM), spin-transfer torque (STT)-Magnetoresistive random-access memory (MRAM), among others. The techniques can also be applied to charge-trapping based memory devices, e.g., silicon-oxide-nitride-oxide-silicon (SONOS) memory devices, and floating-gate based memory devices. The techniques can be applied to three-dimensional (3D) memory devices. The techniques can be applied to various memory types, such as memory devices configured to operate in a single-level cell (SLC) mode, a multi-level cell (MLC) mode, a triple-level cell (TLC) mode, a quad-level cell (QLC) mode, or a penta-level cell (PLC) mode. Additionally or alternatively, the techniques can be applied to various types of devices and systems, such as secure digital (SD) cards, embedded multimedia cards (eMMC), universal flash storage (UFS), or solid-state drives (SSDs), embedded systems, among others.

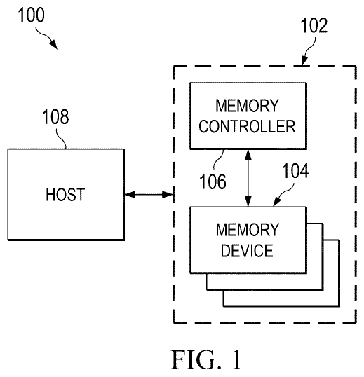

FIG. 1 illustrates a block diagram of an example system 100 having a memory device, according to some aspects of the present disclosure. The system 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, the system 100 can include a host 108 and a memory system 102 having one or more memory devices 104 and a memory controller 106. The host 108 can include one or more processors of an electronic device. The processor can be a central processing unit (CPU), or a system-on-chip (SoC), such as an application processor (AP). The host 108 can be configured to send or receive data and commands to or from the memory systems 102.

The memory device 104 can be any memory device disclosed in the present disclosure, such as a NAND Flash memory device. It is noted that the NAND Flash is only one example of memory device for illustrative purposes. It can include any suitable solid-state, non-volatile memory, e.g., NOR Flash, Ferroelectric RAM (FeRAM), Phase-change memory (PCM), Magne-to-resistive random-access memory (MRAM), Spin-transfer torque magnetic random-access memory (STT-RAM), or Resistive random-access memory (RRAM), etc. In some implementations, memory device 104 includes a three-dimensional (3D) NAND Flash memory device.

The memory controller 106 can be implemented by microprocessors, microcontrollers (a.k.a. microcontroller units (MCUs)), digital signal processors (DSPs), application-specific integrated circuits (ASICs), field-programmable gate arrays (FPGAs), programmable logic devices (PLDs), state machines, gated logic, discrete hardware circuits, and other suitable hardware, firmware, and/or software configured to perform the various functions described below in detail.

The memory controller 106 is coupled to the memory device 104 and to the host 108, and is configured to control the memory device 104, according to some implementations. The memory controller 106 can manage the data stored in the memory device 104 and can communicate with the host 108. In some implementations, the memory controller 106 is designed for operating in a low duty-cycle environment, such as secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment solid state drives (SSDs) or embedded multi-media-cards (eMMCs) used as data storage for mobile devices, such as smartphones, tablets, laptop computers, etc., and enterprise storage arrays. The memory controller 106 can be configured to control operations of the memory device 104, such as read, erase, and program operations. The memory controller 106 can also be configured to manage various functions with respect to the data stored or to be stored in the memory device 104 including, but not limited to bad-block management, garbage collection, logical-to-physical address conversion, logical-to-physical mapping management, wear leveling, etc. In some implementations, the memory controller 106 is further configured to process error correction codes (ECCs) with respect to the data read from or written to the memory device 104. Any other suitable functions can be performed by the memory controller 106 as well, for example, formatting the memory device 104.

The memory controller 106 can communicate with an external device (e.g., the host 108) according to a particular communication protocol. For example, the memory controller 106 can communicate with the external device through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc. The memory controller 106 is configured to receive and transmit a command to and from the host 108, and execute or perform multiple functions and operations provided in the present disclosure, which will be described later.

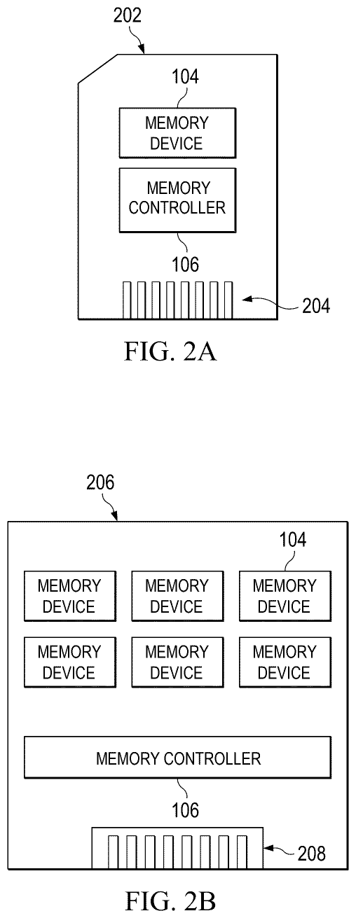

The memory controller 106 and the one or more memory devices 104 can be integrated into various types of storage devices. For example, the memory controller 106 and the one or more memory devices 104 can be packaged in a universal Flash storage (UFS) package or an eMMC package. In one example as shown in FIG. 2A, the memory controller 106 and a single memory device 104 can be integrated into a memory card 202. The memory card 202 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. The memory card 202 can further include a memory card connector 204 coupling the memory card 202 with a host (e.g., host 108 in FIG. 1). In another example as shown in FIG. 2B, the memory controller 106 and multiple memory devices 104 can be integrated into an SSD 206. The SSD 206 can further include an SSD connector 208 that couples the SSD 206 with a host (e.g., host 108 in FIG. 1). In some implementations, the storage capacity and/or the operation speed of the SSD 206 is greater than those of the memory card 202.

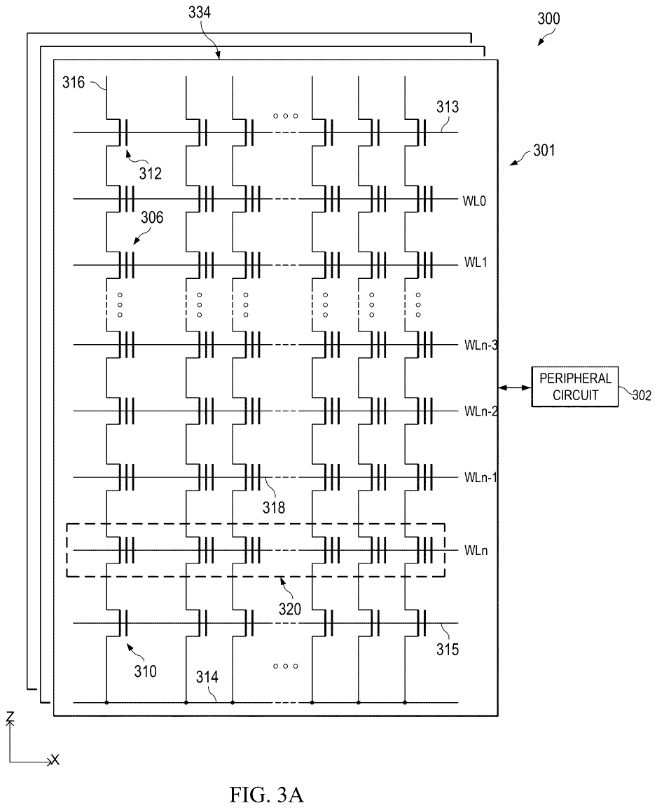

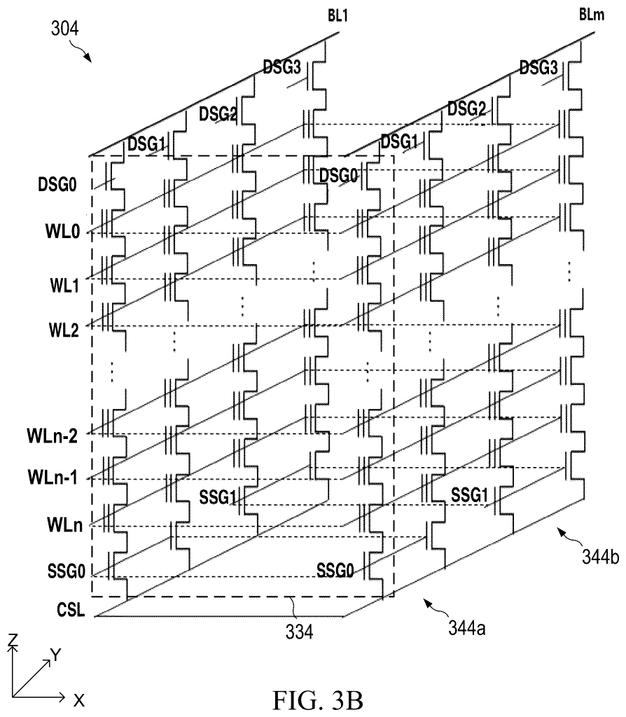

FIG. 3A illustrates an example of a schematic circuit diagram of a memory device 300, according to some aspects of the present disclosure. The memory device 300 can include a memory array 301 and peripheral circuits 302 coupled to the memory array 301. The memory array 301 can be a NAND flash memory array that includes NAND memory cells 306 arranged in rows and columns. In some implementations, memory cells 306 in a column (e.g., along z direction) of the memory array 301 are coupled in series and stacked vertically. Memory cells 306 in a row (e.g., along x direction) of the memory array 301 are coupled to and controlled by a word line 318. Each memory cell 306 can hold a continuous, analog value, such as an electrical voltage or charge that depends on the number of electrons trapped within a storage layer of the memory cell 306. The logic state (i.e., data) of each memory cell 306 can be determined based on the threshold voltage Vth of the memory cell 306. Each memory cell 306 can be a floating gate type memory cell including a floating-gate transistor, or a charge trap type memory cell including a charge-trap transistor.

In some implementations, each memory cell 306 may be a single-level cell (SLC) with two possible memory states that can store one bit of data. For example, the first memory state “0” can correspond to a first range of voltages, and the second memory state “1” can correspond to a second range of voltages. In some implementations, each memory cell 306 may be a multi-level cell (MLC) that is capable of storing more than one bit of data in more than two memory states. For example, the MLC can store two bits per cell, three bits per cell (also known as triple-level cell (TLC)), four bits per cell (also known as a quad-level cell (QLC)), or five bits per cell (also known as a penta-level cell (PLC)). Each MLC can be programmed to support a range of possible nominal storage values. In one example, if each MLC stores two bits of data, then the MLC can be programmed to one of three possible programming levels from an erased state by writing one of three possible nominal storage values to the cell. A fourth nominal storage value can be used for the erased state.

As shown in FIG. 3A, memory cells 306 in a column of the memory array 301 can be coupled to a source select gate (SSG) transistor 310 at its source end, and a drain select gate (DSG) transistor 312 at its drain end. The SSG transistor 310 and the DSG transistor 312 can be configured to activate selected columns of the memory array 301 during read and program operations. In some implementations, sources of the SSG transistors in the same memory block are coupled through a same source line 314 (a.k.a., common source line, CSL). The drain of each DSG transistor is coupled to a respective bit line 316. From the bit line 316, data can read from, or written to memory cells in the column of memory array 301. In some implementations, each column of the memory array 301 is configured to be selected or deselected by applying a DSG select voltage or a DSG unselect voltage to the gate of the respective DSG transistor 312 through one or more DSG lines 313, and/or by applying a select voltage or a unselect voltage to the gate of the respective SSG transistor 310 through one or more SSG lines 315.

In some implementations, the memory cells 306 in adjacent columns can be coupled through word lines 318 to form a memory page 320. The word line 318 can select which row of memory cells 306 is affected by read and program operations. In some implementations where memory cells 306 are SLCs, a memory page 320 of memory cells 306 can store one logical page of data, and therefore corresponds to one logical page. In some implementations where memory cells 306 are MLCs, a memory page 320 of memory cells 306 can store two logical pages of data, and therefore corresponds to two logical pages. In some implementations where memory cells 306 are TLCs, a memory page 320 of memory cells 306 can store three logical pages of data, and therefore corresponds to three logical pages. In some implementations where memory cells 306 are QLCs, a memory page 320 of memory cells 306 can store four logical pages of data, and therefore corresponds to four logical pages. In some implementations, where memory cells 306 are PLCs, a memory page 320 of memory cells 306 can store five logical pages of data, and therefore corresponds to five logical pages.

The size of one memory page 320 in bits is associated with the number of columns of memory cells coupled by word line 318 in a block. Each word line 318 can include a gate line coupled to a plurality of control gates (gate electrodes) of a plurality of memory cells 306 in the respective memory page 320. Example word lines shown in FIG. 3A include WL0, WL1, . . . , WLn−3, WLn−2, WLn−1, and WLn that are between one or more DSG line 313 and one or more SSG line 315.

In some implementations, the memory array 301 can include a plurality of memory blocks (e.g., a memory block 304 as shown in FIG. 3B), and each memory block can include a plurality of strings 334. As shown in FIG. 3A, each string 334 can include memory cells 306 arranged in rows (e.g., coupled to word lines along x direction) and in columns (e.g., connected in series along z direction). Different strings 334 in the same memory block are coupled together to the same source line 314. DSG lines 313 of different strings 334 are separate from each other, so that each string 334 in the memory block can be selected or deselected by applying a select voltage or an unselect voltage to the respective DSG lines 313.

Peripheral circuits 302 can be coupled to memory array 301 through bit lines 316, word lines 318, source lines 314, SSG lines 315, and DSG lines 313. Peripheral circuits 302 can include any suitable analog, digital, and mixed-signal circuits for facilitating the operations of memory array 301.

FIG. 3B illustrates an example of a schematic diagram of a memory block 304 including strings 334, according to some aspects of the present disclosure. In some implementations, each memory block 304 can serve as a basic data unit for erase operations, such that memory cells 306 in the same memory block 304 are erased at the same time. To erase memory cells 306 in a selected memory block 304, the source line 314 coupled to the selected memory block 304 can be biased with an erase voltage. For example, the erase voltage can be a high positive voltage (e.g., 20 V or more). In some implementations, an erase operation can be performed at a half-memory block level, a quarter-memory block level, or a level having any suitable number of memory blocks or fractions of a memory block.

The memory block 304 can include a plurality of strings 334. In some implementations, the memory block 304 can be divided into fingers 344. Each finger 344 can include one or more strings 334. SSG transistors 310 of strings 334 in the same finger 344 are coupled to the same SSG line 315. For example, SSG transistors 310 of strings 334 of the first finger 344a are coupled to a first SSG line represented by SSG0; SSG transistors 310 of strings 334 of the second finger 344b are coupled to a second SSG line represented by SSG1.

In some implementations, DSG transistors 312 of different strings 334 are coupled to different DSG lines 313. For example, DSG transistors 312 of a first string in the memory block 304 are coupled to a first DSG line represented by DSG0; DSG transistors 312 of a second string in the memory block 304 are coupled to a second DSG line represented by DSG1; DSG transistors 312 of a third string in the memory block 304 are coupled to a third DSG line represented by DSG2; and DSG transistors 312 of a fourth string in the memory block 304 are coupled to a fourth DSG line represented by DSG3.

In some implementations, memory pages 320 of the same vertical position (e.g., along z direction) in all strings 334 of the memory block 304 are coupled to the same word line. That is, a word line can be coupled to one memory page 320 of each string 334 of the memory block 304.

In some implementations, the memory block 304 can include a different number of fingers 344, and each finger 344 can include a different number of strings 334. In some implementations, the strings 334 are not arranged in to fingers 344, such that SSG transistors of all strings 334 of the memory block 304 are coupled to the same SSG line.

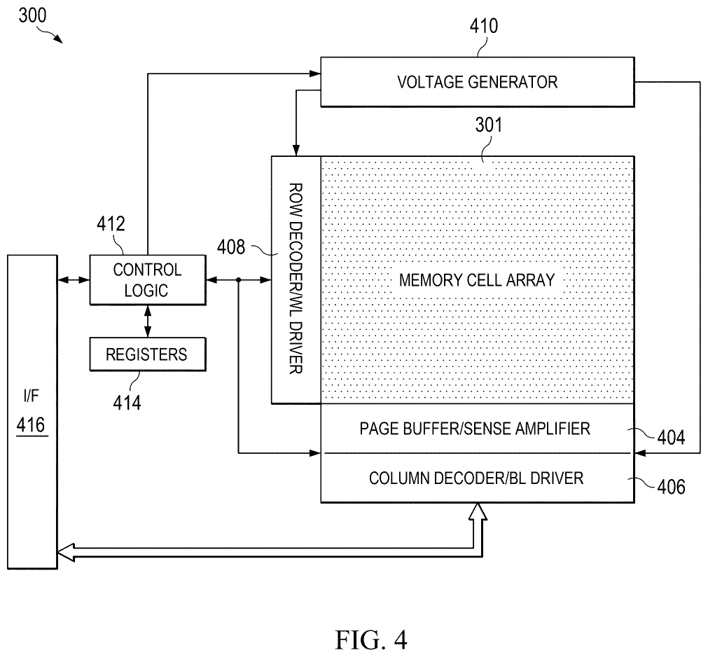

FIG. 4 illustrates some example peripheral circuits 302, according to some aspects of the present disclosure. The peripheral circuits 302 can be coupled to the memory array 301 through bit lines 316, word lines 318, source lines 314, SSG lines 315, and DSG lines 313. The peripheral circuits 302 can include any suitable analog, digital, and mixed-signal circuits for facilitating the operations of the memory array 301 by applying and sensing voltage signals and/or current signals to and from each target memory cell 306 through bit lines 316, word lines 318, source lines 314, SSG lines 315, and DSG lines 313. The peripheral circuits 302 can include various types of peripheral circuits formed using metal-oxide-semiconductor (MOS) technologies. The example peripheral circuits 302 include a page buffer/sense amplifier 404, a column decoder/bit line driver 406, a row decoder/word line driver 408, a voltage generator 410, control logic 412, registers 414, an interface 416, and a data bus. In some examples, additional peripheral circuits not shown in FIG. 4 may be included as well.

The page buffer/sense amplifier 404 can be configured to read and program (write) data from and to memory array 301 according to the control signals from control logic 412. In an example, the page buffer/sense amplifier 404 may store one page of program data (write data) to be programmed into one memory page 320 of the memory array 301. In another example, the page buffer/sense amplifier 404 may perform program verify operations to ensure that the data have been properly programmed into memory cells 306 coupled to selected word lines 418. In still another example, the page buffer/sense amplifier 404 may also sense the low power signals from the bit line 316 that represents a data bit stored in memory cell 306, and amplify the small voltage swing to recognizable logic levels in a read operation. The column decoder/bit line driver 406 can be configured to be controlled by the control logic 412 and select one or more columns of memory cells by applying bit line voltages generated from the voltage generator 410.

The row decoder/word line driver 408 can be configured to be controlled by the control logic 412 and select/deselect memory blocks of the memory array 301 and select/deselect word lines 418 of the memory block. The row decoder/word line driver 408 can be further configured to drive word lines 418 using word line voltages generated from the voltage generator 410. In some implementations, the row decoder/word line driver 408 can also select/deselect and drive SSG lines 315 and DSG lines 313. As described below in detail, the row decoder/word line driver 408 is configured to apply a program voltage to selected word line 418 in a program operation on memory cell 306 coupled to selected word line 418.

The voltage generator 410 can be configured to be controlled by the control logic 412 and generate the word line voltages (e.g., read voltage, program voltage, pass voltage, local voltage, verify voltage, etc.), bit line voltages, and source line voltages to be supplied to the memory array 301.

The control logic 412 can be coupled to each peripheral circuit described above and configured to control the operations of each peripheral circuit. The registers 414 can be coupled to the control logic 412 and include status registers, command registers, and address registers for storing status information, command operation codes (OP codes), and command addresses for controlling the operations of each peripheral circuit.

The interface 416 can be coupled to the control logic 412 and act as a control buffer to buffer and relay control commands received from a host (not shown) to the control logic 412 and status information received from the control logic 412 to the host. The interface 416 can also be coupled to the column decoder/bit line driver 406 via a data bus, and act as a data input/output (I/O) interface and a data buffer to buffer and relay data to and from the memory array 301.

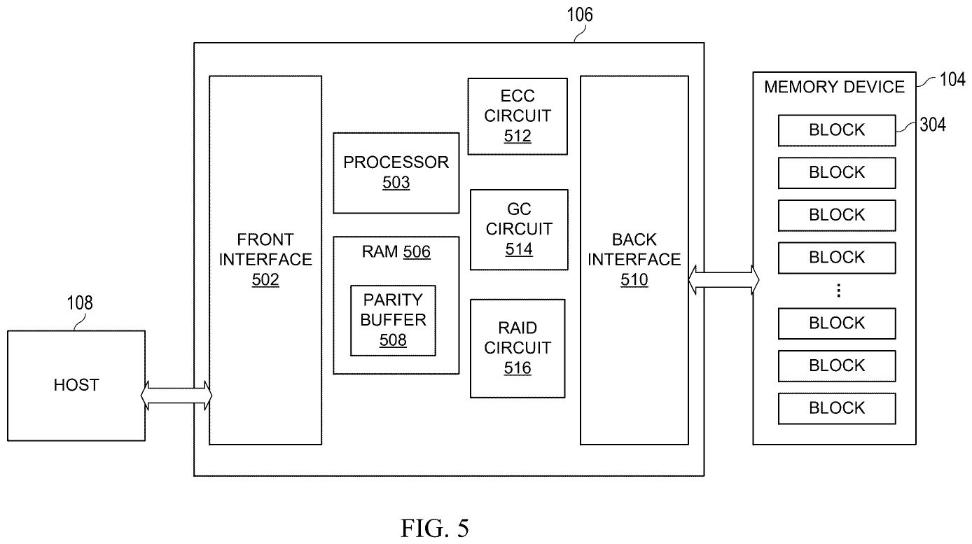

FIG. 5 illustrates an example of a block diagram of a memory controller 106 interacting with a host 108 and a memory device 104, according to some aspects of the present disclosure.

The memory controller 106 can include a front interface 502, one or more processors 503, a Random-Access Memory (RAM) 506, and a back interface 510. The RAM 506 can include one or more parity buffers 508. The memory controller 106 can further include an error-correction code (ECC) circuit 512, a garbage collection (GC) circuit 514, and a redundant array of independent disks (RAID) circuit 516. In some examples, additional components not shown in FIG. 5 may be included in the memory controller 106 as well.

The front interface 502 can be configured to handle communications between the host 108 and the memory controller 106. In some implementations, the front interface 502 can communicate with the host 108 according to a particular communication protocol. For example, the front interface 502 can communicate with the host 108 through at least one of various interface protocols, such as a USB protocol, an MMC protocol, a PCI protocol, a PCI-E protocol, an ATA protocol, a serial-ATA protocol, a parallel-ATA protocol, a SCSI protocol, an ESDI protocol, an IDE protocol, a Firewire protocol, etc. In some implementations, the front interface 502 can receive a request from the host 108 and forward the request to the back interface 510, so that the back interface 510 can fulfill the request. Examples of a request can include, but are not limited to, a read request to read data stored in a memory block of memory device 104, an erase request to erase the data in the memory block, a write request to write new data into the memory block, a reformatting request to reformat the memory device 104, or any other suitable request. In some implementations, the front interface 502 can receive data from the back interface 510, and send the data to the host 108.

The back interface 510 can be configured to fulfill requests from host 108. In some implementations, the back interface 510 can receive a request from the host 108 via the front interface 502, and perform one or more operations to fulfill the request. For example, the back interface 510 can be configured to control operations of memory device 104 (e.g., read, erase, or program operations) in response to receiving a request from host 108 (e.g., a read request, an erasing request, or a programming request). The back interface 510 can also be configured to manage various functions with respect to the data stored or to be stored in the memory device 104 including, but not limited to, bad-block management, error correction, wear leveling, garbage collection, RAID parity check, etc.

The ECC circuit 512 is configured to process error correction codes with respect to the data read from or written to the memory device 104. Example error correction codes can include, but are not limited to, Hamming codes, Reed-Solomon codes, low-density parity check (LDPC) codes, etc. In some implementations, the ECC circuit 512 includes an LPDC encoder configured to generate parity data based on LDPC codes for user data received from the host 108, so that both the user data and the parity data can be sent to the memory device 104 for storage. The ECC circuit 512 can further include an LDPC decoder configured to decode data comprising the user data and the parity data. The ECC circuit can determine whether data stored in the block is read successfully (e.g., with no errors). If the data stored in the block is read successfully, the back interface 510 can forward the data to the front interface 502, so that the front interface 502 can return the data to the host 108. However, if the data stored in the memory block is not read successfully, the back interface 510 can generate data describing a read error on the memory block.

The GC circuit 514 can be configured to migrate data from a source memory block to a target memory block, so that the source memory block can be erased to be available for writing new data. For example, the GC circuit 514 can be configured to select a source memory block and a target memory block in the memory device 104, read valid data from the source memory block by sending read commands to the memory device 104, write the valid data to the target memory block by sending write commands to the memory device 104, and then erase the source memory block. In some implementations, the GC circuit 514 can be configured to perform foreground garbage collection on the memory device 104, where the garbage collection is performed when there are not enough memory blocks available for writing new data. In some implementations, the GC circuit 514 can be configured to perform background garbage collection on the memory device 104, where the garbage collection is performed while the memory device is idle (e.g., when there is no pending command to be executed by the memory device).

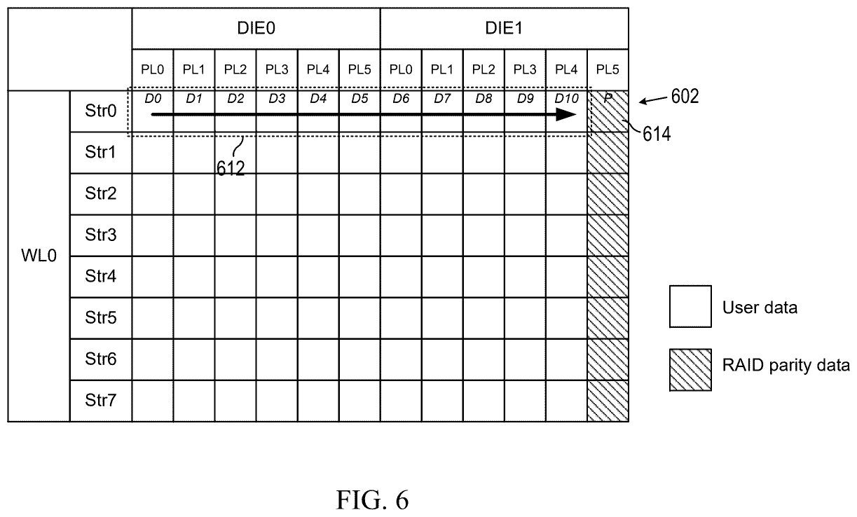

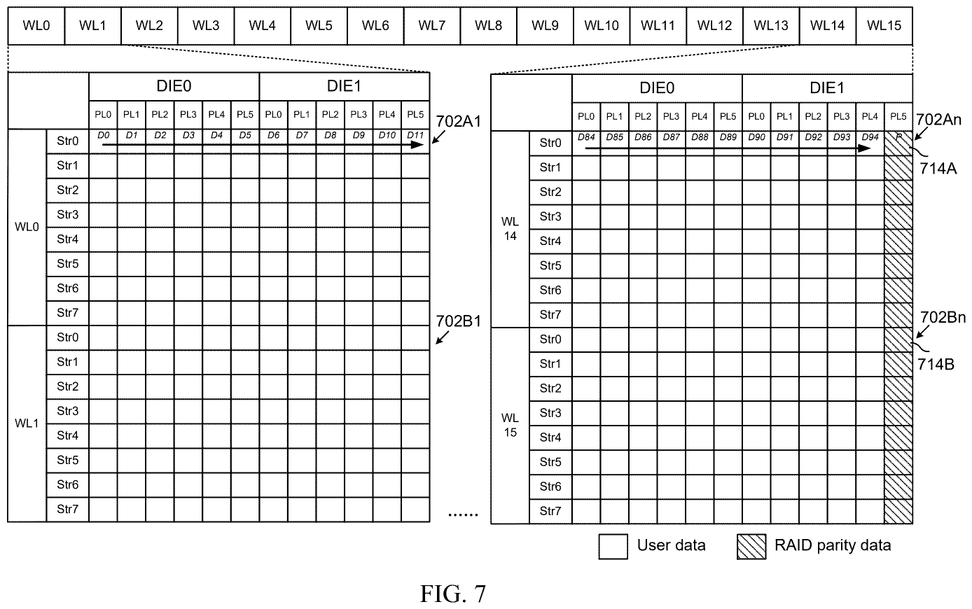

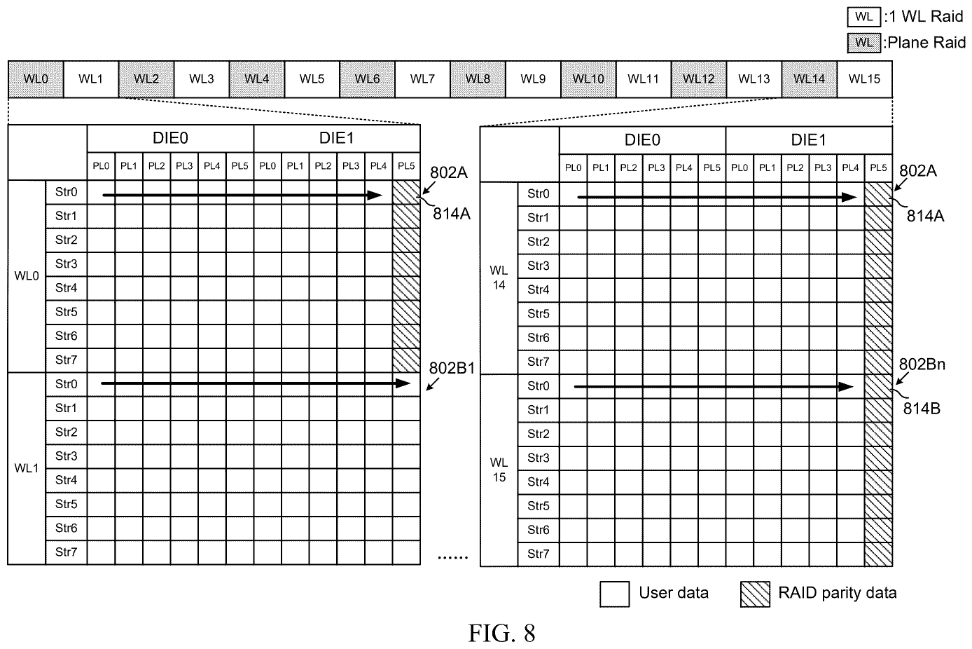

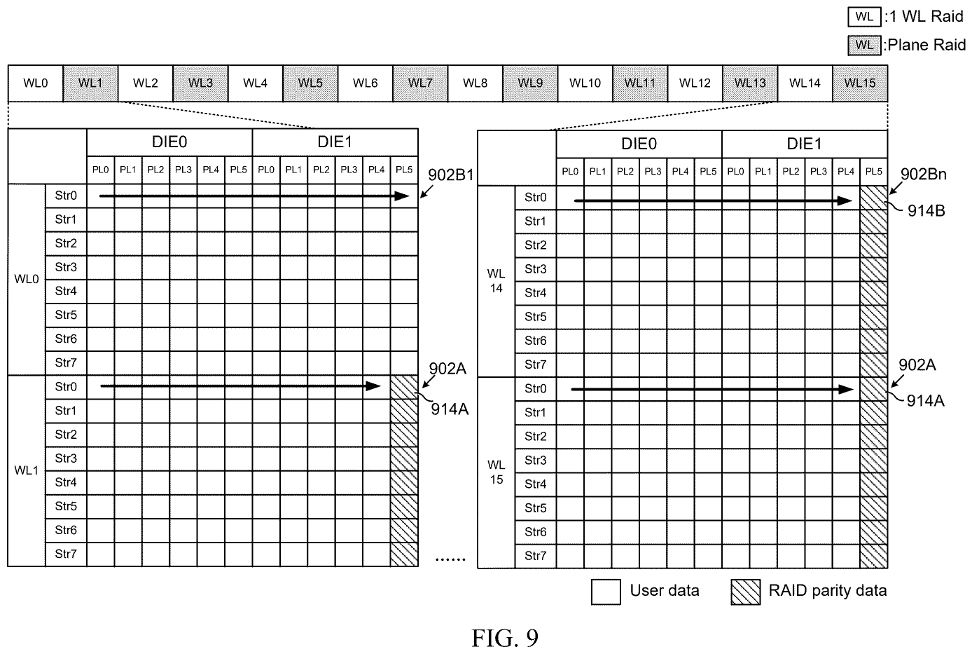

The RAID circuit 516 can be configured to generate RAID parity data by performing encoding operations on data to be written to the memory device 104, and writing the data and the corresponding RAID parity data to memory blocks 304 of the memory device. The memory device 104 can be managed under a RAID scheme, which employs techniques of striping, mirroring, and/or parity to create large reliable data storage across multiple storage units. In some implementations, the memory device 104 can include multiple dies, where each die includes multiple planes. Each plane includes multiple memory blocks. Each memory block can include memory pages (e.g., memory pages 320 of FIG. 3A). Memory pages located at the same position (e.g., associated with word lines of identical numbers and included in strings of identical numbers) across different planes in at least one die can form a page line (e.g., page line 602 of FIG. 6, page line 702 of FIG. 7, page line 802 of FIG. 8, or page line 902 of FIG. 9). The RAID circuit 516 can perform exclusive OR (XOR) operations among data in one or more page lines to generate respective RAID parity data.

As an example shown in FIGS. 6-9, the memory device includes 2 dies, DIE0 and DIE1. Each die includes 6 planes, PL0-PL5. Each plane includes a plurality of memory blocks. Each memory block includes memory pages that are coupled to a plurality of word lines (e.g., WL0-WLn). The number of memory pages coupled to one word line in each memory block corresponds to the number of strings (e.g., string 334 of FIG. 3B) included in the memory block. For example, the memory blocks each include 8 strings (Str0-Str7), such that in each memory block, a word line is coupled to 8 memory pages. One page line (e.g., represented by a row of cells), for example, page line 602 of FIG. 6, page line 702 of FIG. 7, page line 802 of FIG. 8, or page line 902 of FIG. 9, can include 12 memory pages (e.g., each memory page represented by a cell). The 12 memory pages in a page line are coupled to word lines of identical numbers and are located in strings of identical numbers across the 6 planes of each of the 2 dies. For instance, the 12 memory pages in a first page line 602 are each coupled to WL0 and located in Str0 in a first memory block across the 12 planes; the 12 memory blocks in a second page line are coupled to WL0 and located in Str1 in the first memory block across the 12 planes. It should be noted that the memory device can include any other suitable number of dies and other suitable number of planes, and that each page line can include any other suitable number of memory pages.

Referring back to FIG. 5, the one or more processors 503 are configured to control operations of the memory controller 106. The one or more processors 503 are configured to control a read operation, a program operation, an erase operation, or other operations of the memory device 104.

The RAM 506 is configured to be used as an operation memory of the one or more processors 503, a cache memory between the memory device 104 and the host 108, and/or a buffer memory between the memory device 104 and the host 108. In some implementations, the RAM 506 can be a Static Random-Access Memory (SRAM). The RAM 506 can include one or more parity buffers 508 configured to store RAID parity data, and/or the intermediate results of XOR operations to generate the RAID parity data. In some implementations, the RAM 506 can further include a read buffer configured to temporarily store data that are read from the memory device 104, a copy buffer configured to temporarily store data to be written to the memory device 104, or the like.

In some implementations, each parity buffer 508 may have a limited memory space (e.g., 320 KB). In case the RAID parity data and/or the intermediate results exceed the memory space of the parity buffer 508, the memory controller 106 can use other buffers (e.g., the read buffer and the copy buffer) in the RAM 506 to store the RAID parity data and/or the intermediate results. In case the RAID parity data and/or the intermediate results exceed available buffer space in the RAM 506, the memory controller 106 can perform a swap operation, e.g., sending the RAID parity data and/or the intermediate results in the parity buffer 508 to the memory device 104 for temporary storage, and retrieve RAID parity data and/or the intermediate results from the memory device 104 when needed.

FIG. 6 illustrates an example data structure of a memory device (e.g., the memory device 104 of FIGS. 1-2B and 5, the memory device 300 of FIG. 3A) under a Plane RAID scheme, according to some aspects of the present disclosure. Under the Plane RAID scheme, a memory controller (e.g., the memory controller 106 of FIGS. 1-2B and 5) can generate RAID parity data 614 corresponding to one page line 602 by performing XOR operations among data portions that include user data 612 in the page line 602, and store the RAID parity data 614 as one data portion in the page line 602 (e.g., the last data portion in the page line 602). A data portion can be data stored in a memory page included in the page line 602. Under the scenario where one page line 602 includes T data portions (where T is a positive integer), under the Plane RAID scheme, the ratio of the volume of RAID parity data 614 to the volume of user data 612 in the memory device is 1:(T−1).

In case of failure (e.g., programming failure or read failure) in one data portion in the page line 602, the memory controller can recover the compromised data portion, e.g., by performing XOR operations, using the RAID parity data 614 of the target page line 602 and the rest of the data portions in the target page line 602. Under the Plane RAID scheme, in case of failure in one data portion in each of two page lines 602 associated with adjacent word lines (e.g., the page line associated with Str0 and WL0 and the page line associated with Str0 and WL1), the compromised data portions can still be recovered.

As one example shown in FIG. 6, the first page line includes 12 data portions that are each associated with a memory page coupled to WL0 and located in Str0 in a first memory block among the 12 planes. Under the Plane RAID scheme, the first 11 data portions (D0-D10) include user data 612, and the last data portion (P) includes RAID parity data 614 that is generated by performing XOR operations among the first 11 data portions, such that P=D0 ⊕D1 ⊕D2 ⊕ . . . ⊕D10. RAID parity data of other page lines can be generated in similar approaches. In this example, the ratio of the volume of RAID parity data 614 to the volume of user data 612 in the memory device is 1:11.

Before writing first RAID parity data (e.g., RAID parity data corresponding to one page line) to the memory device, the memory controller stores the intermediate results for generating the first RAID parity data in the parity buffer (e.g., parity buffer 508 of FIG. 5) of the memory controller. After writing the first RAID parity data to the memory device, the parity buffer can be freed up and available for storing intermediate results for generating second RAID parity data (e.g., RAID parity data corresponding to the following page line). As such, under the Plane RAID scheme, the parity buffer may only need to store intermediate results of RAID parity data corresponding to one page line, which is typically within the storage capacity of the RAM of the memory controller. As such, the memory controller may not need to use other buffers as parity buffer, or to perform swap operations to store the intermediate results.

FIG. 7 illustrates an example data structure of a memory device (e.g., the memory device 104 of FIGS. 1-2B, the memory device 300 of FIG. 3A) under a 2WL RAID scheme, according to some aspects of the present disclosure. Under the 2WL RAID scheme, a memory controller (e.g., the memory controller 106 of FIGS. 1-2B and 5) can generate RAID parity data 714 (including 714A and 714B) corresponding to page lines 702 (including 702A1, 702B1, . . . , 702An, 702Bn) associated with a group of word lines that are separated from one another by one word line. In some implementations, a first group of word lines include a set of even-numbered word lines, and a second group of word lines include a set of odd-numbered word lines. With respect to the first group of word lines, the memory controller can perform XOR operations on data portions in page lines 702A1, . . . , 702An associated with the first group of word lines to generate corresponding RAID parity data 714A, and store the RAID parity data 714A as one data portion (e.g., the last data portion) of the last page line 702An associated with the first group of word lines. With respect to the second group of word lines, the memory controller can perform XOR operations on data portions in page lines 702B1, . . . , 702Bn associated with the second group of word lines to generate corresponding RAID parity data 714B, and store the RAID parity data 714B as one data portion (e.g., the last data portion) of the last page line 702Bn associated with the second group of word lines.

Under the scenario where one page line 702 includes T data portions and the first and second groups of word lines each include W word lines (where T and W are both positive integers), under the 2WL RAID scheme, the ratio of the volume of RAID parity data to the volume of user data in the memory device is 1:(W*T−1).

In case of programming failure or read failure in one data portion in a page line 702, the memory controller can recover the compromised data portion, e.g., by performing XOR operations, using the RAID parity data 714 generated based on multiple page lines 702 including the target page line, and the rest of the data portions in the multiple page lines 702. Under the 2WL RAID scheme, in case of failure in one data portion in each of two page lines 702A and 702B associated with adjacent word lines (e.g., the page line associated with Str0 and WL0 and the page line associated with Str0 and WL1), the compromised data portions can still be recovered.

As one example shown in FIG. 7, the first group of word lines include WL0, WL2, . . . , and WL14, and the second group of word lines include WL1, WL3, . . . , WL15. Under the 2WL RAID scheme, for each group of word lines, the memory controller generates RAID parity data 714 by performing XOR operations among data portions in page lines 702 associated with strings of identical numbers. For instance, with respect to the first group of word lines, the page line 702A1 associated with Str0 and WL0 includes 12 data portions (D0-D11) that include user data, the page line associated with Str0 and WL2 includes 12 data portions (D12-D23, not shown in FIG. 7) that include user data, . . . , and the page line 702An associated with Str0 and WL14 includes 11 data portions (D84-D94) that include user data and one data portion P that includes RAID parity data 714A, where the RAID parity data 714A is generated as P=D0⊕D1⊕ . . . ⊕D11⊕D12 ⊕D13⊕ . . . ⊕23⊕ . . . ⊕D84⊕D85⊕ . . . ⊕D94. Similarly, the last data portion in the page line associated with StrX (X=0, 1, 2, . . . , 7) and WL14 include RAID parity data 714A that is generated by performing XOR operations among data portions in page lines 702 associated with StrX and each of WL0, WL2, . . . , and WL14. With respect to the second group of word lines, the last data portion in the page line 702Bn associated with StrX (X=0, 1, 2, . . . , 7) and WL15 includes RAID parity data 714B that is generated by performing XOR operations among data portions in page lines 702 associated with StrX and each of WL1, WL3, . . . , and WL15. In this example, the ratio of the volume of RAID parity data to the volume of user data in the memory device is 1:95.

It should be noted that the first group of word lines and the second group of word lines can include other suitable number of word lines. After writing RAID parity data 714 corresponding to page lines 702 associated with the first group of word lines and the second group of word lines, the memory controller can write user data to page lines 702 associated with a third group of word lines (e.g., WL16, WL18, . . . , WL30) and a fourth group of word lines (e.g., WL17, WL9, . . . , WL31), and generate RAID parity data 714 corresponding to the page lines 702 associated with the third and the fourth groups of word lines.

In some implementations, the memory device writes user data following the sequence of the page line number, e.g., from the page line associated with WL0 and Str0, to the page line associated to WL0 and Str1, . . . , to the page line associated with WL0 and Str7, to the page line associated with WL1 and Str0, and so on. Under the 2WL RAID scheme, the results of the XOR operations among data portions in one page line (e.g., each page line associated with WL0 and WL1) are not yet the final RAID parity data to be written to the memory device, therefore the results will be retained in the parity buffer for further XOR operations. As such, the parity buffer may need to store intermediate results of RAID parity data corresponding to twice the number of page lines associated with each word line, e.g., 16 page lines in the example shown in FIG. 7). The volume of the intermediate results may therefore be large. As such, when the volume of intermediate results exceeds the storage capacity of the parity buffer, on top of using other buffer space as parity buffer, the memory controller may further need to perform swap operations to store the intermediate results, which may affect the efficiency of write operations.

FIG. 8 illustrates an example data structure of a memory device (e.g., the memory device 104 of FIGS. 1-2B and 5, the memory device 300 of FIG. 3A) under a RAID scheme that combines Plane RAID and 2WL RAID, according to some aspects of the present disclosure. Under the RAID scheme that combines Plane RAID and 2WL RAID, a memory controller (e.g., the memory controller 106 of FIGS. 1-2B and 5) can generate RAID parity data 814A corresponding to page lines 802A associated with a first group of word lines using the Plane RAID scheme, and generate RAID parity data 814B corresponding to page lines 802B1, . . . , 802Bn (collectively 802B) associated with a second group of word lines using the 2WL RAID scheme. Under the scenario where one page line 802 (including 802A and 802B) includes T data portions and the first and groups of word lines each include W word lines (where T and W are both positive integers), the overall ratio of the volume of RAID parity data to the volume of user data in the memory device is

$$[ \frac{1}{( W * T - 1 )} + \frac{1}{T - 1} ] \times \frac{1}{2} .$$

In some implementations, the first group of word lines include even-numbered word lines (e.g., WL0, WL2, . . . , WL14), where the memory controller generates RAID parity data 814A by performing XOR operations among data portions in each page line 802A, and stores the RAID parity data 814A as the last data portion in the page line 802A. The second group of word lines include odd-numbered word lines (e.g., WL1, WL3, . . . , WL15), where the memory controller generates RAID parity data 814B by performing XOR operations among data portions in page lines 802B1, . . . , 802Bn associated with each one of the second group of word lines, and store the RAID parity data 814B as the last data portion in the last page line 802Bn associated with the second group of word lines.

As an example shown in FIG. 8, the first group of word lines include WL0, WL2, . . . , and WL14, and the second group of word lines include WL1, WL3, . . . , WL15. The last data portion in each page line 802A associated with WL0, WL2, . . . and WL14 includes RAID parity data 814A generated under the Plane RAID scheme. The last data portion in each page line 802Bn associated with WL15 includes RAID parity data 814B generated under the 2WL RAID scheme. For example, the last data portion in the page line associated with Str0 and WL0 includes the RAID parity data 814A generated by performing XOR operations among the 11 data portions in this page line 802A that include user data; the last data portion in the page line associated with Str0 and WL14 includes the RAID parity data 814A generated by performing XOR operations among the 11 data portions in the page line that include user data; and the last data portion in the page line associated with Str0 and WL15 includes the RAID parity data 814B generated by performing XOR operations among the 95 data portions (that include user data) across 8 page lines associated with Str0 and each of WL1, WL3, . . . , and WL15. In this example, the overall ratio of the volume of RAID parity data to the volume of user data in the memory device is

$$[ \frac{1}{11} + \frac{1}{95} ] \times \frac{1}{2} .$$

In some implementations, as shown in FIG. 9, the first group of word lines include odd-numbered word lines (e.g., WL1, WL3, . . . , WL15), where the memory controller generates RAID parity data 914A by performing XOR operations among data portions in each page line 902A, and stores the RAID parity data 914A as the last data portion in the page line 902A. The second group of word lines include even-numbered word lines (e.g., WL0, WL2, . . . , WL14), where the memory controller generates RAID parity data 914B by performing XOR operations among data portions in page lines 902B1, . . . , 902Bn (collectively 902B) associated with each one of the second group of word lines, and store the RAID parity data 914B as the last data portion in the last page line 902Bn associated with the second group of word lines.

As an example shown in FIG. 9, the first group of word lines include WL1, WL3, . . . , and WL15, and the second group of word lines include WL0, WL2, . . . , and WL14. The last data portion in each page line 902A associated with WL1, WL3, . . . and WL15 includes RAID parity data 914A generated under the Plane RAID scheme. The last data portion in each page line 902Bn associated with WL14 includes RAID parity data 914B generated under the 2WL RAID scheme. For example, the last data portion in the page line associated with Str0 and WL1 include the RAID parity data 914A generated by performing XOR operations among the 11 data portions in this page line that include user data; the last data portion in the page line associated with Str0 and WL15 includes the RAID parity data 914A generated by performing XOR operations among the 11 data portions in the page line that include user data; and the last data portion in the page line associated with Str0 and WL14 includes the RAID parity data 914B generated by performing XOR operations among the 95 data portions (that include user data) across 8 page lines associated with Str0 and each of WL0, WL2, . . . , and WL14.

In case of programming failure or read failure in one data portion in a page line 802A, 902A associated with the first group of word lines, the memory controller can recover the compromised data portion, e.g., by performing XOR operations, using the RAID parity data 814A, 914A of the target page line and the rest of the data portions in the target page line. In case of programming failure or read failure in one data portion in a page line 802B, 902B associated with the second group of word lines, the compromised data portion can be recovered, e.g., by performing XOR operations, using the RAID parity data 814B, 914B generated based on multiple page lines including the target page line, and the rest of the data portions in the multiple page lines. Under the RAID scheme that combines Plane RAID and 2WL RAID, in case of failure in one data portion in each of two page lines 802A and 802B, or 902A and 902B associated with adjacent word lines (e.g., the page line associated with Str0 and WL0 and the page line associated with Str0 and WL1), the compromised data portions can still be recovered.

Under the RAID scheme that combines Plane RAID and 2WL RAID, regarding the first group of word lines, the RAID parity data 814A or 914A is generated under the Plane RAID scheme. The RAID parity data 814A or 914A can be written to the same page line as the corresponding user data, such that the parity buffer only needs to store intermediate results of RAID parity data 814A or 914A corresponding to one page line. Regarding the second group of word lines, the RAID parity data 814B or 914B is generated under the 2WL RAID scheme. Intermediate results of the RAID parity data 814B or 914B need to be retained in the parity buffer during the process of writing user data to the preceding page lines (e.g., all page lines associated with WL1 to WL14), such that the parity buffer needs to store intermediate results of RAID parity data 814B or 914B corresponding to the number of pages lines associated with one word line (e.g., 8 page lines in the example shown in FIG. 8 or FIG. 9). Compared to the 2WL RAID scheme (e.g., as shown in FIG. 7), the volume of the intermediate results to be stored in the parity buffer may be less. As such, when the volume of intermediate results exceeds the storage capacity of the parity buffer, the memory controller may only need to user other buffer space as parity buffer, without needing to perform swap operations.

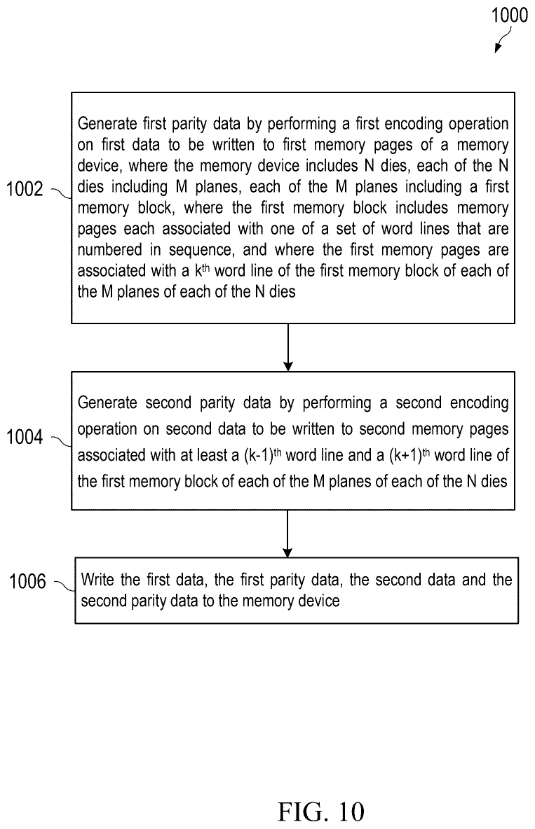

FIG. 10 illustrates a flowchart of an example process 1000 of operating a memory system, in accordance with some aspects of the present disclosure. Process 1000 can be performed by any suitable device or system as described herein, for example, according to the example techniques described with respect to FIGS. 1-9. For example, process 1000 can be performed by a memory system (e.g., the memory system 102 of FIG. 1) that includes a memory device (e.g., the memory device 104 of FIGS. 1-2B and 5, the memory device 300 of FIG. 3A) and a memory controller (e.g., the memory controller 106 of FIGS. 1-2B and 5). The memory device can include N dies, and each die includes M planes, where N and M are positive integers. Each plane includes one or more memory blocks (e.g., the memory blocks 304 of FIG. 3B). Each memory block includes memory pages (e.g., memory pages 320 of FIG. 3A) each associated with one of a set of word lines (e.g., WL0-WLn) that are numbers in sequence.

The operations shown in process 1000 may not be exhaustive and other operations can be performed as well before, after, or in between any of the illustrated operations. Further, some of the operations may be performed simultaneously, or in a different order than shown in FIG. 10. In some implementations, some of the operations may be performed by one or more components of a device or a system, such as, a peripheral circuit of the memory device, or a memory controller of a memory system.

At 1002, the memory controller generates first parity data (e.g., RAID parity data 814A of FIG. 8 or RAID parity data 914A of FIG. 9) by performing a first encoding operation on first data to be written to first memory pages (e.g., memory pages 320 of FIG. 3A), where the first memory pages are associated with a k^{th} word line of a first memory block of each of the M planes of each of the N dies. The first data can be user data to be stored as data portions in a page line (e.g., page line 802A of FIG. 8, or page line 902A of FIG. 9) associated with the k^{th} word line. The first encoding operations include XOR operations among data portions in the page line associated with the k^{th} word line. Each data portion can represent data stored in one memory page of the first memory pages.

At 1004, the memory controller generates second parity data (e.g., RAID parity data 814B of FIG. 8 or RAID parity data 914B of FIG. 9) by performing a second encoding operation on second data to be written to second memory pages (e.g, memory pages 320 of FIG. 3A), where the second memory pages are associated with at least a (k−1)^{th} word line and a (k+1)^{th} word line of the first memory block of each of the M planes of each of the N dies. The second data can be user data to be stored as data portions in page lines (e.g., page lines 802B of FIG. 8, or page lines 902B of FIG. 9) associated with a group of word lines that include at least the (k−1)^{th} word line and the (k+1)^{th} word line. The group of word lines are separated from one another by one word line (e.g., including a set of odd-numbered word lines as shown in FIG. 8, or including a set of even-numbered word lines as shown in FIG. 9). The second encoding operations include XOR operations among data portions in the page lines associated with the group of word lines that include at least the (k−1)^{th} word line and the (k+1)^{th} word line.

In some implementations, the first parity data is generated based on a Plane RAID scheme, and the second parity data is generated based on a 2WL RAID scheme. A first ratio of the volume of the first parity data to the volume of the first data is greater than a second ratio of the volume of the second parity data to the volume of the second data.

In some implementations, the memory controller generates the first parity data and the second parity data (e.g., by the RAID circuit 516 of FIG. 5) in response to receiving, from a host (e.g., the host 108 of FIGS. 1 and 5), one or more write commands to write the first data and the second data to the memory device. In response to detecting a read failure when reading the first data from the memory device, the memory controller can use the first parity data to recover a failed data portion in the first data. In response to detecting a read failure when reading the second data from the memory device, the memory controller can use the second parity data to recover a failed data portion in the second data.

At 1006, the memory controller writes the first data, the first parity data, the second data, and the second parity data to the memory device.

In some implementations, the first parity data is written to a memory page associated with the k^{th} word line of the first memory block of the M^{th} plane of the N^{th} die (e.g., as the last data portion in the page line associated with the k^{th} word line). The second parity data is written to a memory page with the (k+1)^{th} word line of the first memory block of the M^{th} plane of the N^{th} die (e.g., as the last data portion in the last page line associated with the group of word lines that include at least the (k−1)^{th} word line and the (k+1)^{th} word line).

In some implementations, before writing the first parity data and the second parity data to the memory device, the memory controller can store the intermediate results of the XOR operations for generating the first parity data and the second parity data in a buffer (e.g., the parity buffer 508 of FIG. 5) of the memory controller. The memory controller may not need to perform swap operations to temporarily store the intermediate results to the memory device.

The present disclosure also provides a non-transitory computer-readable storage medium. The non-transitory computer-readable storage medium stores one or more instructions (e.g., firmware of a memory controller) that are executable by a computer system. When being executed by the computer system, the instructions in the storage medium can implement the method for managing parity data as shown in FIGS. 1-9.

The non-transitory computer-readable storage medium can be an internal storage unit of the device described in any of the foregoing embodiments. For example, the non-transitory computer-readable storage medium can be a hard disk or an internal memory of the device. The non-transitory computer-readable storage medium can also be an external storage device of the device, such as a plug-in hard disk, a smart media card (SMC), a secure digital (SD) card, a flash card, etc. Further, the non-transitory computer-readable storage medium can also include an internal storage unit and an external storage device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations, but should be defined only in accordance with the following claims and their equivalents. Accordingly, other implementations also are within the scope of the claims.

What is claimed is:

1. A memory system, comprising:
a memory device comprising N dies, each of the N dies comprising M planes, each of the M planes comprising a first memory block, where N, M are positive integers, wherein the first memory block comprises memory pages each associated with one of a set of word lines that are numbered in sequence; and
a memory controller coupled to the memory device, wherein the memory controller is configured to perform operations comprising:
generating first parity data by performing a first encoding operation on first data to be written to memory pages associated with a k^{th} word line of the first memory block of each of the M planes of each of the N dies, where k is an integer greater than 1;
generating second parity data by performing a second encoding operation on second data to be written to memory pages associated with at least a (k−1)^{th} word line and a (k+1)^{th} word line of the first memory block of each of the M planes of each of the N dies; and
writing the first data, the first parity data, the second data and the second parity data to the memory device.

2. The memory system of claim 1, wherein the first parity data and the second parity data comprise redundant array of independent disks (RAID) parity data.

3. The memory system of claim 1, wherein the second parity data is generated by performing the second encoding operation on the second data to be written to memory pages that are associated with a group of odd-numbered word lines of the first memory block of each of the M planes of each of the N dies.

4. The memory system of claim 1, wherein the second parity data is generated by performing the second encoding operation on the second data to be written to memory pages that are associated with a group of even-numbered word lines of the first memory block of each of the M planes of each of the N dies.

5. The memory system of claim 1, wherein a first ratio of a volume of the first parity data to a volume of the first data is greater than a second ratio of a volume of the second parity data to a volume of the second data.

6. The memory system of claim 1, wherein the first parity data is written to a memory page associated with the k^{th} word line of the first memory block of the M^{th} plane of the N^{th} die, and
wherein the second parity data is written to a memory page associated with the (k+1)^{th} word line of the first memory block of the M^{th} plane of the N^{th} die.

7. The memory system of claim 1, wherein the memory controller is configured to perform the operations in response to receiving, from a host, one or more write commands to write the first data and the second data.

8. The memory system of claim 1, wherein the first encoding operation and the second encoding operation each comprise a plurality of exclusive OR (XOR) operations, wherein results of the plurality of XOR operations are stored in a buffer of the memory controller.

9. The memory system of claim 1, wherein the operations comprise:
in response to detecting a read failure when reading the first data, recovering the first data using the first parity data; or
in response to detecting a read failure when reading the second data, recovering the first data using the first parity data.

10. A memory controller, comprising:
one or more processors and an interface, wherein the one or more processors are configured to perform operations comprising:
sending, through the interface, one or more first write commands to write first data and first parity data to a memory device, wherein the memory device comprises N dies, each of the N dies comprising M planes, each of the M planes comprising a first memory block, where N, M are positive integers, wherein the first memory block comprises memory pages each associated with one of a set of word lines that are numbered in sequence, wherein the first parity data is generated by performing a first encoding operation on the first data to be written to memory pages associated with a k^{th} word line of the first memory block of each of the M planes of each of the N dies, where k is a positive integer; and
sending, through the interface, one or more second write commands to write second data and second parity data to the memory device, wherein the second parity data is generated by performing a second encoding operation on second data to be written to memory pages associated with at least a (k−1)^{th} word line and a (k+1)^{th} word line of the first memory block of each of the M planes of each of the N dies.

11. The memory controller of claim 10, wherein the first parity data and the second parity data comprise redundant array of independent disks (RAID) parity data.

12. The memory controller of claim 10, wherein the second parity data is generated by performing the second encoding operation on the second data to be written to memory pages that are associated with a group of odd-numbered word lines of the first memory block of each of the M planes of each of the N dies.

13. The memory controller of claim 10, wherein the second parity data is generated by performing the second encoding operation on the second data to be written to memory pages that are associated with a group of even-numbered word lines of the first memory block of each of the M planes of each of the N dies.

14. The memory controller of claim 10, wherein a first ratio of a volume of the first parity data to a volume of the first data is greater than a second ratio of a volume of the second parity data to a volume of the second data.

15. The memory controller of claim 10, wherein the first parity data is written to a memory page associated with the k^{th} word line of the first memory block of the M^{th} plane of the N^{th} die, and
wherein the second parity data is written to a memory page associated with the (k+1)^{th} word line of the first memory block of the M^{th} plane of the N^{th} die.

16. The memory controller of claim 10, wherein the memory controller is configured to perform the operations in response to receiving, from a host, one or more write commands to write the first data and the second data.

17. The memory controller of claim 10, wherein the first encoding operation and the second encoding operation each comprise a plurality of exclusive OR (XOR) operations, and wherein results of the plurality of XOR operations are stored in a buffer of the memory controller.

18. The memory controller of claim 10, wherein the operations comprise:
in response to detecting a read failure when reading the first data, recovering the first data using the first parity data; or
in response to detecting a read failure when reading the second data, recovering the first data using the first parity data.

19. A method of operating a memory system, comprising:
generating first parity data by performing a first encoding operation on first data to be written to first memory pages of a memory device, wherein the memory device comprises N dies, each of the N dies comprising M planes, each of the M planes comprising a first memory block, where N, M are positive integers, wherein the first memory block comprises memory pages each associated with one of a set of word lines that are numbered in sequence, and wherein the first memory pages are associated with a k^{th} word line of the first memory block of each of the M planes of each of the N dies, where k is a positive integer;
generating second parity data by performing a second encoding operation on second data to be written to second memory pages associated with at least a (k−1)^{th} word line and a (k+1)^{th} word line of the first memory block of each of the M planes of each of the N dies; and
writing the first data, the first parity data, the second data and the second parity data to the memory device.

20. The method of claim 19, wherein a first ratio of a volume of the first parity data to a volume of the first data is greater than a second ratio of a volume of the second parity data to a volume of the second data.
